(19) United States
(12) Patent Application Publication
(10) Pub. No.: US 2006/0029707 A1
(43) Pub. Date: Feb. 9, 2006

(54) Food products and food intermediates having low acrylamide content comprising cyclodextrin and amino acids, salts or derivatives thereof, and methods

(76) Inventors: David W. Plank, Taylors Falls, MN (US); Kory M. Kolvig, Minneapolis, MN (US)

Correspondence Address: GENERAL MILLS, INC., P.O. BOX 1113, MINNEAPOLIS, MN, 55440, US

(21) Appl. No.: 11/196,916

(22) Filed: Aug. 4, 2005

Related U.S. Application Data
(60) Provisional application No. 60/599,107, filed on Aug. 5, 2004.

(51) Int. Cl. A21D 10/00

(52) U.S. Cl. 426/549

(57) ABSTRACT

Food products and food intermediates having reduced acrylamide content are provided. The food product or food intermediate comprises a first component that is a cyclodextrin; and a second component that is a non-endogenous food ingredient material selected from amino acids, salts thereof and derivatives thereof. Methods for controlling the amount of measured acrylamide in a food product or food intermediate are also provided.

### REFERENCE TO RELATED APPLICATIONS

This application claims the benefit of priority under 35 U.S.C. § 119(e)(1) of a provisional patent application, Ser. No. 60/599,107, filed Aug. 5, 2004, which is incorporated herein by reference in its entirety.

### FIELD OF THE INVENTION

The invention relates to food products and food intermediates having low acrylamide content. More specifically, the invention relates to food products and food intermediates having low acrylamide content comprising cyclodextrin and amino acid or salts or derivatives thereof.

### BACKGROUND

Acrylamides have been classified as a potential carcinogen and neurotoxin that has been recently discovered to exist in varying levels in processed foods, such as fried, baked and cooked foods that are made from grain and vegetable based products such as potatoes. It has been proposed that acrylamide is formed as a result of the Maillard reaction between amino acids and reducing sugars. Asparagine, a major amino acid found in cereals (grains) and potatoes is thought to be the significant player in acrylamide production. Asparagine has an amide group attached to a chain of two carbon atoms. The degradation of the amino acids in the presence of dicarbonyl products from the Mailard reaction causes the amino acid to become decarboxylated and deaminated to create an aldehyde. When glucose and asparagines are reacted at elevated temperatures, particularly those above 100° C., more typically above 120° C. and usually above 185° C. significant levels of acrylamides may be produced.

Cyclodextrins have been used principally for the encapsulation of insoluble compounds on a molecular basis in order to enhance stability, reduce volatility and alter solubility as well as to increase shelf life of certain products. Such prior uses of cyclodextrins have been limited to flavor carriers and protection of sensitive substances against thermal decomposition, oxidation and degradation. In addition, more recently, cyclodextrins have also been used to remove fatty acids and cholesterol from animal fats and to remove cholesterol and cholesterol esters from egg yolks. U.S. Pat. Nos. 5,498,437, 5,342,633 and 5,063,077 discuss various processes for the removal of cholesterol and cholesterol esters from egg yolks, meat, animal fats, etc. It is thought that by reducing the level of cholesterol in such foodstuffs that overall levels of cholesterol may be reduced in consumers. However, processing steps to such foodstuffs increases the cost of delivering such products to market.

### SUMMARY OF THE INVENTION

The present invention relates to a food products and food intermediates having reduced acrylamide content. The food product or food intermediates comprises a first component that is a cyclodextrin and a second component that is a non-endogenous food ingredient material selected from selected from amino acids, salts thereof and derivatives thereof. While not being bound by theory, it is believed that the effectiveness in reduction of acrylamide generation by incorporation of either cyclodextrin or amino acids, salts or derivatives thereof is limited due to the amount of material that may be effectively incorporated in the food product or food intermediate. Surprisingly, incorporation of both cyclodextrin and amino acids, salts or derivatives thereof in a food product or food intermediate does not result in reduction of the effectiveness of either component by interaction between these components, but rather results in surprising levels of reduction in acrylamide generation.

For purposes of the present invention, the first and second components are considered to be incorporated in the food product or food intermediate either if intimately mixed with the ingredients of the food product or food intermediate, or if topically applied to the food product or food intermediate. In one embodiment of the present invention, both the first and second components are intimately mixed with the ingredients of the food product or food intermediate. In another embodiment both the first and second components are topically applied to the food product or food intermediate. In another embodiment, one of the first and second components is intimately mixed with the ingredients of the food product or food intermediate and the other of the first and second components is topically applied to the food product or food intermediate. In another embodiment, both the first and second components are intimately mixed with the ingredients of the food product or food intermediate, and also are topically applied to the food product or food intermediate.

In an embodiment of the present invention, the first and second components as described above are incorporated in the food product or food intermediate in an amount sufficient to provide a food product or food intermediate having an amount of measurable acrylamide that is less than 90%, 50% or 10% by parts of the amount of acrylamide in a like food article that does not contain the first and second components.

The present invention also provides a method of controlling the amount of measured acrylamide in a food product or food intermediate. In this method, a food product or food intermediate is selected in which the level of measured acrylamide is to be controlled. First and second components are incorporated in the food product or food intermediate, wherein the first component is a cyclodextrin and the second component is a non-endogenous food ingredient material selected from amino acids, salts or derivatives thereof.

### BRIEF DESCRIPTION OF THE DRAWINGS

FIG. 1 is a chart showing that acrylamide formation decreases in a linear fashion with increasing alpha-cyclodextrin concentration.

FIG. 2 is a chart showing inhibition of acrylamide formation in compositions containing lysine, alpha-cyclodextrin, and both lysine and alpha-cyclodextrin.

FIG. 3 is a chart showing precipitation of [14C]-Asparagine by alpha-cyclodextrin.

FIG. 4 is a chart showing that increasing concentrations of alpha-cyclodextrin cause a molecular weight shift of [14 C]-asparagine.

FIG. 5 is a chart showing complexation of alpha-cyclodextrin with [14C]-asparagine.

### DETAILED DESCRIPTION

The term “food product” as used herein relates to a food article that is ready for consumption, either in an uncooked state or in a cooked state. The term “food intermediate” as used herein relates to a food article that is in an intermediate step and requires further handling prior to consumption, such as assembly or treatment such as by cooking in order to prepare the product for human or animal consumption. Food products and food intermediates as provided hereunder in particular include any food products or food intermediates derived from or containing grain or vegetable based components. Examples of grain include wheat, rice, oats, barley, and the like. Examples of vegetable based components include corn and potato.

Food products of the present invention particularly include baked goods such as muffins, rolls, cakes, pies, crackers, pastries, biscuits and breads and the like; snack bars such as grain based bars, granola bars, health food bars, fruit bars, and the like; ready to eat (“R-T-E”) cereals, i.e. grain or vegetable based products in the form of flakes, extruded shapes or puffed, and optionally containing fruits and/or nuts or other such ingredients, such as corn flakes, puffed wheat, puffed rice, raisin bran flakes, and the like; fried or baked snack foods such as potato crisps, corn chips, tortilla chips, extruded snacks, enrobed extruded snacks, pretzels and the like; dairy products such as yogurt, pudding, and the like, and beverages, such as nutritional beverages and energy drinks.

Food intermediates of the present invention particularly include additives, supplements or ingredients useful in preparing or supplementing a food article. Examples of such additives, supplements or ingredients include sauces, pasta, toasted bread crumbs, taco shells, pie crusts, rice noodles/chow mein noodles, crackers, snack food components and the like. Food intermediates of the present invention also particularly include fully prepared compositions that are in a raw state, partially cooked state, or a fully cooked state but requiring a further treatment step prior to consumption, such as baking dough to produce bread, or heating a refrigerated or frozen snack or meal prior to consumption. Examples of such fully prepared compositions include prepared soups, entrees and meals; vegetable products such as French fries; doughs (particularly refrigerated or frozen doughs, such as biscuits, breads, rolls, crescent rolls, croissants, cookies, and the like) toaster pastries; and filled dough products, such as refrigerated or frozen egg rolls, pizza rolls, burritos, and the like. A typical pizza roll generally includes an outer shell, formed from a dough product, and a filling, which may include a wide variety of ingredients such as cheeses, meats, sauces, etc.

In an embodiment of the present invention, the first and second components are incorporated in a food product or a food intermediate prior to cooking. As used herein, the term “cooking” comprised heating, baking, frying, steaming, boiling, stewing and other steps generally imparted to food products and food intermediates to prepare them for human or animal consumption. Cooking includes the use of microwave and radiant energy. In general, the step of drying and/or cooking or other steps of imparting heat to the food product or the food intermediate results in the food article developing desired flavor and color attributes via the Mailard reaction. While not being bound by theory, it is believed that imparting heat to the food product or the food intermediate greatly accelerates generation of acrylamide in the food article. Thus, incorporation of the first and second components in the food product or food intermediate prior to imparting heat and particularly prior to cooking is particularly advantageous. It is noted, however, that acrylamides may be formed in food products even without a heating step. Food products and food intermediates of the present invention that are not subsequently cooked therefore may additionally benefit from incorporation of the first and second components as described herein.

For purposes of the present invention, the amount of acrylamide content in a food product is measured at the time the food product is made available for consumption. The amount of acrylamide content in an intermediate food product can be measured at the time the food product is made available to a third party for subsequent preparation, which is hereby designated the “as provided food intermediate acrylamide content,” or after preparation by the third party, which is hereby designated the “cooked food intermediate acrylamide content.”In embodiments of the present invention, the food product comprises less than about 1000 ppm, or less than about 500 ppm, or less than about 100 ppm, or less than about 100 ppb of acrylamide. In additional embodiments of the present invention, the food intermediate has an as provided food intermediate acrylamide content of less than about 1000 ppm, or less than about 500 ppm, or less than about 100 ppm, or less than about 100 ppb of acrylamide. In alternative embodiments of the present invention, it is valuable to project the amount of acrylamide that would be produced by the non-manufacturing consumer by cooking the food intermediate, and provide a food intermediate that results in an acrylamide content that is below predetermined levels when cooked per the instructions and/or expectations of the manufacturer. In embodiments of this aspect of the present invention, the food intermediate has a cooked food intermediate acrylamide content of less than about 1000 ppm, or less than about 500 ppm, or less than about 100 ppm, or less than about 100 ppb of acrylamide.

The first component to be incorporated in the food product of the present invention is a cyclodextrin. Cyclodextrins comprise a doughnut shaped or cyclical structure composed of a number of alpha-D-glucose units (typically 6-8) having a hydrophilic exterior and a hydrophobic interior. The cyclodextrin component in one embodiment of the present invention comprises alpha-cyclodextrin, beta-cyclodextrin, gamma-cyclodextrin, or mixtures thereof. Cyclodextrins are generally water soluble, although alpha-cyclodextrin is likely more water soluble than beta-cyclodextrin or gamma-cyclodextrin, and free flowing crystalline powders that are substantially if not completely odorless and white in color.

In one embodiment of the invention, the cyclodextrin is alpha-cyclodextrin. Alpha-cyclodextrin is a cyclized ring of six alpha 1,4 linked glucose units. Alpha-cyclodextrin has a cavity dimension of about 0.50×0.79 (nm). The solubility of alpha-cyclodextrin at 25° C. is 14 (gm/100 mL). Alpha-cyclodextrin is available from Wacker Specialties, Adrian, Mich. 49221 and sold under the trademark CAVAMAX® W6 Wacker-Chemie, Burghausen, Germany.

In another embodiment of the invention, alpha-cyclodextrin is used in combination or synergistically with beta-cyclodextrin and/or gamma-cyclodextrin, in particular ratios dependent upon the requirements of the ultimate user. In an exemplary embodiment, alpha-cyclodextrin may be used individually or may be combined with between 0-50% by weight beta-cyclodextrin or gamma-cyclodextrin or with between 0.1 to about 40% by weight beta-cyclodextrin. Beta-cyclodextrins and gamma-cyclodextrins are also available from Wacker Specialties, Adrian, Mich. 49221.

In an embodiment of the invention, the first component is present in an amount of from about 0.01% to about 75% by weight of the food product or food intermediate. In another embodiment, the first component is present in an amount of from about 0.05% to about 15% or 1% to about 10% by weight of the food product or food intermediate.

One method of preparing cyclodextrins includes enzymatic treatment. Enzymatic degradation or treatment of the starch to produce cyclodextrins useful in the present invention is done through the use of cyclodextrin glucosyltransferase (CGTase, EC 2.4.1.19) or other enzymes, which results in a cyclic ring of sugar. In one method, cyclodextrins are produced by the action of cyclodextrin glucosyltransferase on hydrolyzed starch syrups at neutral pH (6.0-7.0) and moderate temperature (35-40° C.). Alternatively, cyclodextrins can be produced in planta by the expression of the gene encoding CGTase in the food plant of interest.

The second component to be incorporated in the food product of the present invention is a non-endogenous food ingredient material selected from amino acids, salts or derivatives thereof. By “non-endogenous” is meant that the amino acids, salts or derivatives thereof that may naturally occur in the food product raw material, such as grain, flour and so forth that would conventionally be present in such raw materials.

Exemplary amino acids include lysine, isoleucine, phenylalanine, tyrosine, cysteine, cystine, leucine, methionine, serine, threonine, glutamate, aspartate, proline, tryptophan, valine; alanine, glycine, arginine, histidine, salts thereof, derivatives thereof, and mixtures thereof. Salts may be formed from these amino acids from any ionic moiety appropriate for consumption. Examples of such salt counterions include sodium, potassium, calcium, lithium and barium. For purposes of the present invention, derivatives of the amino acids include amino acid containing compounds comprising moieties that do not deleteriously affect the acrylamide generation reduction properties of the amino acid. Examples of such moieties include aldehyde groups and the like.

In one embodiment of the invention, the amino acid used is lysine. Lysine is considered one of the essential amino acids and has a chemical structure of NH₂(CH₂)₄CH(NH₂)COOH, and has been assigned the CAS number 56-87-1. Lysine is generally a colorless crystal that is soluble in water, slightly soluble in alcohol and insoluble in ether. Lysine can be extracted from natural proteins; created synthetically by fermentation of glucose or other carbohydrates; or by synthesis from caprolactam. Other available forms of lysine include DL-Lysine and L-Lysine monohydrocholoride.

In an embodiment of the invention, the second component is incorporated in an amount ranging from about 0.01% to about 50% by weight, or from about 2% to about 20% by weight, or from about 5 to about 10% by weight of the food product or food intermediate.

The present invention is particularly beneficial in food products having a minimum amount of ingredients believed to facilitate formation of acrylamide. Thus, in an embodiment of the present invention, food products that additionally comprise asparagine in an amount greater than about 30 ppb; and a compound comprising a carbonyl or aldehyde functionality in an amount greater than about 30 ppb find particular benefit in incorporation of the first and second components as discussed herein. In one aspect of this embodiment, the compound comprising a carbonyl or aldehyde functionality is a reducing sugar. Examples of some reducing sugars include allose, altrose, glucose, mannose, gulose, idose, galactose, talose, arabinose, ribose, and xylose.

In embodiments of the invention, the food product has a pH of from about 4 to about 7, or from about 5 to about 6.

In an exemplary embodiment in the preparation of a light colored cooked cereal composition such as a cereal dough or a cereal mass, a cooked cereal dough can be prepared by blending various dry cereal ingredients together with water and cooking to gelatinize the starchy components so as to develop a cooked flavor. A pre-blend of wet ingredients may be prepared and combined with a pre-blend of the dry ingredients. The cooked cereal material or mass can also be mechanically worked to form cooked cereal dough. The cooking and mechanical work can occur simultaneously or sequentially. The dry ingredients can also include various cooked cereal dough additives such as sugar(s), salt and mineral salts, and starches. In addition to water, various liquid ingredients such as malt syrups can be added. A cooked cereal mash is quite similar to cooked cereal dough except that larger sized particles such as whole grains or cut grains are cooked rather than cereal flour ingredients.

While the invention finds particular suitability for use in connection with the provision of ready to eat (“R-T-E”) cereals fabricated from cooked cereal doughs, the skilled artisan will appreciate that the present cooked cereal doughs can find applicability for use in connection with other grain based food products such as grain and vegetable based snack products. For example, the cooked cereal doughs can be formed into suitably sized, shaped and partially dried pellets or intermediates. These intermediates are useful in forming finished products. Finished grain or vegetable based snack products are usually provided by the deep fat frying or other puffing of the pellets (e.g., hot air or microwave heating) of partially dried intermediate products fabricated from cooked cereal doughs.

An advantage of producing intermediates is that they can be produced in bulk in one location and thereafter fried in one or more finish operations to form the finished snack products. Not only are shipping costs reduced due to the reduced volume of the intermediates compared to the finished products but also breakage of the finished product is reduced.

The cereal dough cooking step can be practiced using a batch, atmospheric cooker and a low pressure extruder cooker especially those equipped with a conditioner pre-cooker, or a twin screw extruder. The cereal dough is cooked with steam and sufficient amounts of added water for times and at temperatures sufficient to gelatinize the cereal starch and to develop desired levels of cooked cereal flavor.

The present exemplary method, for purposes of illustration, comprises the step of forming the cooked cereal dough or mass into individual pieces of a predetermined, desirable shape and size and having a particular moisture content. Conventional techniques and equipment can be employed to practice this step and the skilled artisan will have no difficulty in selecting those suitable for use herein.

For example, the dough having a moisture content of about 25% to 30% is first partially dried to a partially dried dough having a moisture content of about 12% to 20%. The partially dried dough can then be fed to piece forming apparatus that forms the partially dried dough into individually shaped and sized pieces.

The present cereal compositions can be fabricated into any of a variety of common R-T-E cereal or snack forms including, shreds, biscuits, flakes, rings, or any common R-T-E cereal or cereal based snack product form, shape or size.

The present cereal compositions can also be formulated and fabricated so as to provide puffed cereals of various shapes and sizes such as “biscuits”. Especially desirable for use herein are biscuits, especially toasted biscuits. With respect to flakes, the forming step can first involve a sub-step of shaping the dough into pellets and then a finish step of shaping the pellets into a final desired shape such as flakes. Shaped or puffed cereals may be extruded through a puffing device or extruded through dies.

The cooked cereal dough can be fed to a pellet former to form pellets. In the preparation of R-T-E cereals in flake form, for example, the pellets can be sized to have a pellet count of about 35 to 50 per 10 g and a moisture content of 16 to 20%. In the preparation of a flaked R-T-E cereal, the pellets can be partially dried to moisture contents of about 18 to 20%. The pellets can then be formed into “wet” flakes having a thickness of about 380 to 635 μm (0.015 to 0.025 inch), preferably while warm 76.6 to 87.8° C. (170 to 190° F.) to form desirably shaped and sized wet flakes.

The dough can also be sheeted to form sheets of dough (e.g., 25 to 800 microns in thickness) and the individual pieces formed by cutting the sheet into individual pieces or by stamping out shaped pieces from the dough sheet.

The cooked cereal dough may also be extruded through a die imparting a desired peripheral shape to form an extrudate cooked cereal dough rope. The dough rope can be cut to form individual shaped pieces. In another variation, the cooked cereal dough is formed into individual “O” shaped pieces or rings, biscuits, shreds, figurines, letters, spheres or flakes or other geometric shapes, nuggets, or even irregular shapes.

Next, the shaped and sized individual pieces are dried to form finished cereal products. The skilled artisan will appreciate that the drying step depends importantly in part upon the desired end product. For example, for end products in the form of puffable intermediates or pellets for snack production, the drying step can be practiced to provide a “finish” moisture content of about 10 to 15%. However, when the desired end product is an R-T-E cereal, drying the pellets to these moisture contents may only be an intermediate or sub-step prior to, for example, flaking the dried pellets to form “wet” flakes. These “wet” flakes can then be subjected to a finish or final drying step wherein the pieces are dried to final dried moisture contents of 1 to 4% such as by toasting.

In another variation, the dough can be extruded under conditions of temperature and pressure so as to puff and expand (the “direct expansion” technique) and sectioned or cut into individual pieces to form individual expansions puffed R-T-E cereal or snack pieces. The cooked cereal dough can be puffable such as by deep fat frying, microwave heating, gun puffing, jet zone heating, etc. to prepare snack products.

The drying step can also involve heating the pieces under conditions that not only dry the piece but also cause the piece to expand to form dried and puffed or flaked finished pieces. For example, pellets can be gun puffed to form dried puffed R-T-E cereal products. The wet flakes can be toasted to dry, expand and tenderize to form finished R-T-E cereal flakes.

The pieces or pellets may also be deep fat fried to form dried puffed fried finished cereal products. Such dried puffed fried finished cereal pieces are especially desirable as snack products. Such products can absorb about 5 to 35% of frying fat during the drying and puffing step.

The first and second components as described herein may be incorporated in the food product as any appropriate step in the food product manufacturing process. As noted above, the first and second components may be intimately mixed with the ingredients of the food product or topically applied to the food product in any combination.

In an embodiment of the invention, the food product is provided as a packaged food product, either in bulk, in multiple servings (i.e. from about 2 to about 20 servings) or as single serving. The thus packaged food product may be provided in the cooked state, or the uncooked state. The thus conveniently provided food product may be protected against acrylamide generation in a format convenient for transportation to a non-manufacturing consumer. For purposes of the present invention, a “non-manufacturing consumer” is a party that does not assemble the raw ingredients of the food product, but instead may undertake one or more subsequent food preparation operations such as subdividing the food product into smaller portions and heating and optionally applying auxiliary ingredients such as sauces and the like to the food product. Examples of such non-manufacturing consumers include institutional food providers such as school cafeterias and hospitals and the like, and restaurants and the like. A sub-group of the non-manufacturing consumer is the retail customer, who is the individual party purchasing the food product for non-commercial use, such as feeding the family in the home.

In one embodiment, this packaging is for microwave heating of the food product by a non-manufacturing consumer. In a specific example of this embodiment, the food product is packaged in a package suitable for placement in a microwave oven. In a more specific example, the package is designed to assist in cooking of the food product in a microwave oven.

The invention will further be described by reference to the following nonlimiting examples.

### EXAMPLES

A. Test Methodology

Acrylamide was measured in food products using the following methodology: Reagents and Consumables
Acrylamide (Sigma Chemical Company, St. Louis, Mo.)
¹³C₃-labeled acrylamide (Cambridge Isotope Laboratory, Andover, Mass.)
HPLC grade acetonitrile (Omnisolv, EM Science, Gibbstown, N.J.)
HPLC grade methanol (Omnisolv, EM Science, Gibbstown, N.J.)
HPLC grade 2-propanol (Omnisolv, EM Science, Gibbstown, N.J.)
HPLC grade water (Omnisolv, EM Science, Gibbstown, N.J.)
Formic acid 99% (Sigma Chemical Company, St. Louis, Mo.)
Glacial acetic acid 99% (Sigma Chemical Company, St. Louis, Mo.)
Maxi-Spin filter tube, 0.45 μm PVDF (Alltech Associates, Deerfield, Ill.)
50 mL polypropylene conical tube with cap (Becton Dickinson)
Hydro-RP 80A HPLC column (2×250 mm), 4 micron packing (Phenomonex, Torrance, Calif.). Wash column a minimum of 20 min with 50:50 methanol:acetonitrile after 48 samples or at end of daily operations. Mobile phase re-equilibration for analyses will require 1.5 hr.

OASIS HLB 6 mL solid phase extraction cartridge, 200 milligram packing (Waters Corporation, Milford, Mass.).

Bond Elut—Accucat (mixed mode, C8, SAX and SCX) 3 mL solid phase extraction cartridge, 200 milligram packing (Varian Inc., Harbor City, Calif.).

A-1 Instrumentation

Agilent (Palo Alto, Calif.) Model 1100 autosampler, binary HPLC pump and column heater

Micromass Inc. (Manchester, UK), Quattro micro triple quadrupole mass spectrometer

A-2 Sample Preparation

1. Crush and homogenize a portion of sample equal to the manufacturer's recommended serving size with a food processor or equivalent device.

2. Weigh a one gram portion of crushed sample into a 50 mL polypropylene graduated conical tube with cap.

3. Add 1 mL of internal standard solution (¹³C₃-labeled acrylamide in 0.1% formic acid, 200 ng/mL), followed by 9 mL of water to the test portion. Shake by hand or vortex briefly to disperse test portion in water prior to step 4.

4. Mix for 20 minutes on a rotating shaker. (Note: Do not heat or sonicate, as this may generate an extract that will clog the Solid Phase Extraction (SPE) column.)

5. Centrifuge at 9000 rpm for 15 min. Promptly remove 5 mL portion of clarified aqueous phase for spin filtration and SPE. Avoid top oil layer and bottom solids layer when removing portion of aqueous phase.

6. Place 5 mL portion in Maxi-Spin filter tube, 0.45 μm PVDF (Alltech #2534). Centrifuge at 9000 rpm for 2-4 min. If filter clogs, insert new filter into tube, pour unfiltered liquid onto new filter and continue centrifugation until most of the liquid has passed through filter.

7. Condition OASIS SPE cartridge with 3.5 mL methanol, followed by 3.5 mL of water. Discard methanol and water portions used to prepare cartridge. A number of SPE cartridges were tested during development of this method, and all of them had different analyte retention and elution characteristics. Do not substitute another SPE sorbent in this step without testing.

8. Load OASIS SPE cartridge with 1.5 mL of the 5 mL test portion extract. Allow extract to pass completely through the sorbent material. Elute column with 0.5 water and discard. Elute column with additional 1.5 mL water and collect for Varian SPE cartridge cleanup. Do not use a vacuum to speed-up the elution process in any of the SPE steps.

9. Place mark on outside of Varian SPE cartridge at height of 1 mL liquid above sorbent bed. Condition Varian SPE cartridge with 2.5 mL methanol, followed by 2.5 ml of water. Discard methanol and water portions used to prepare cartridge. Load 1.5 mL portion collected in step 8 and elute to 1 mL mark before collecting remainder of eluted portion. Transfer to 2 mL auto-sampler vial for LC/MS/MS analysis. This step removes a number of early eluting co-extractives, resulting in better precision for sub-50 ppb measurements. Do not load more than 1.5 mL of extract onto Varian SPE cartridge.

A-3 Liquid Chromatography/Mass Spectrometry:

1. Mobile phase composition: Aqueous 0.1% acetic acid, 0.5% methanol

2. Column flow rate: 200 μL/min Post-column makeup flow rate: 50 μL/min 1% acetic acid in 2-propanol

3. Injection volume: 20 μl

4. Column temperature: 26° C.

5. Acrylamide elution time: approximately 7.1 minutes

6. Ionization Mode: Positive ion electrospray

7. Probe temperature: 240° C.

8. Source temperature: 120° C.

9. Desolvation gas flow: 710 L/hr nitrogen

10. Cone Gas flow: 153 L/hr nitrogen

11. Collision gas pressure: 1 Torr argon

12. MRM ions: Acrylamide (m/z 72, 55, 27), Internal Standard (75, 58, 29).

Collision energy of transitions for MRM: 72>72 and 75>75, 5 volts; 72>55 and 75>58, 10 volts; 72>27 and 75>29, 19 volts. Dwell time 0.3 sec each with 0.02 sec inter-channel and inter-scan delay.

13. Quantitation: Parts per billion acrylamide=(200 ng internal standard)(area of m/z 55)/(area of m/z 58)(g of portion analyzed)(response factor). The response factor is the average response factor obtained from a concurrently run standard curve encompassing the range of apparent acrylamide levels in the test portions. Limit of quantitation is defined as the level at which a 10:1 signal/noise ratio is observed for the analyte quantitation ion (m/z 55).

Inhibition of Acrylamide by Alpha-cyclodextrin in a Food Matrix

### COMPARATIVE EXAMPLE

An oat cereal was produced on a Buhler 42 twin-screw extruder with and without alpha-cyclodextrin added to the ingredients. The cereal was dried to a final moisture of 3% and then assayed for acrylamide as described in A above. Free glucose was also measured as an indicator of alpha-cyclodextrin degradation.

TABLE 1

| | Glucose | |
|---|---|---|
| Variable | (%) | Acrylamide (ppb) |
| Oat Cereal | 0 | 221 |
| Oat Cereal + 2.8% (w/w) Alpha-cyclodextrin | 0 | 185 |
| Oat Cereal + 5.6% (w/w) Alpha-cyclodextrin | 0 | 133 |

In Vitro Test Methodology for Acrylamide

C-1 General Procedure

1. Solution A: Dissolve 13.609 grams Potassium Phosphate Monobasic (KH₂PO₄) in 450 ml dH₂O. Adjust pH of solution to 5.5 with KOH. Bring to final volume of 500 mL with dH2O. Stir thoroughly. (Final Conc.=200 mM KH₂PO₄,pH 5.5).

2. Solution B: Dissolve 0.7507 grams of asparagine in 100 mL of 200 mM KH₂PO₄,pH 5.5. Store in the dark at 4 C until ready for use.

3. Solution B2: For testing lysine and lysine plus alpha-cyclodextrin, 100 mM asparagine stock solutions were used (150.14 grams asparagine dissolved in 100 mL of 200 mM KH₂PO₄, pH 5.5).

4. Solution C: Dissolve 0.901 grams of glucose in 100 mL of 200 mM KH₂PO₄,pH 5.5 (Final Conc.=50 mM glucose). Store in the dark at 4 C until ready for use.

5. Solution C2: For testing lysine and lysine plus alpha-cyclodextrin, 100 mM glucose stock solutions were used (180.2 grams glucose dissolved in 100 mL of 200 mM KH₂PO₄, pH 5.5).

C-2 Method of Measuring Inhibition of Acrylamide Formation with Alpha-Cyclodextrin

1. Weigh out alpha-cyclodextrin into a glass ampule.

2. Add 1 ml of Solution B and 1 ml of Solution C prepared as described above.

3. Vortex until all alpha-cyclodextrin is solubilized.

4. Place ampule on argon/vacuum manifold:
a. Alternately flush sample with argon and then pull vacuum until sample is observed to no longer bump or bubble (˜6 cycles).
b. Apply vacuum to sample for 3 minutes.
c. Seal ampule while pulling vacuum with flame.

5. Place ampule in 110 C oven for 8 hours.

6. Remove ampule from oven and cool to room temperature.

7. Open ampule and filter solution through 0.45 um nylon filter.

8. Inject on to gas chromatograph with FID (see below).

9. Alternatively, detection sensitivity can be increased by spiking each sample with a final concentration 10 ppm acrylamide prior to filtering.

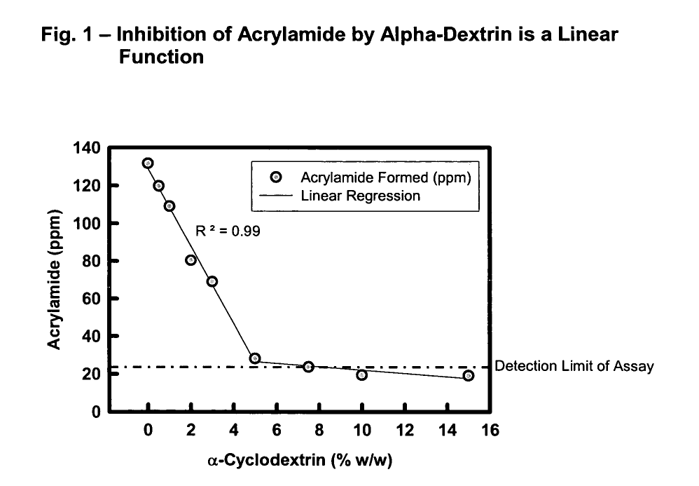

As seen in FIG. 1, acrylamide formation decreases in a linear fashion with increasing alpha-cyclodextrin concentration.

C-3 Method of Measuring Inhibition of Acrylamide Formation with Lysine and Alpha-Cyclodextrin

1. Weigh out alpha-cyclodextrin, Lysine or alpha-cyclodextrin and Lysine into a glass ampule. For low concentrations of Lysine, pre-dissolve lysine in Solution A above and add desired serial dilution to ampule

2. Add 1 ml of Solution B2 and 1 ml of Solution C2 prepared as described above.

3. Vortex until all alpha-cyclodextrin and/or Lysine is solubilized.

4. Place ampule on argon/vacuum manifold:
a. Alternately flush sample with argon and then pull vacuum until sample is observed to no longer bump or bubble (˜6 cycles).
b. Apply vacuum to sample for 3 minutes.
c. Seal ampule while pulling vacuum with flame.

5. Place ampule in 110 C oven for 16 hours.

6. Remove ampule from oven and cool to room temperature.

7. Open ampule and filter solution through 0.45 um nylon filter.

8. Inject on to gas chromatograph with FID (see below).

9. Alternatively, detection sensitivity can be increased by spiking each sample with a final concentration 10 ppm acrylamide prior to filtering.

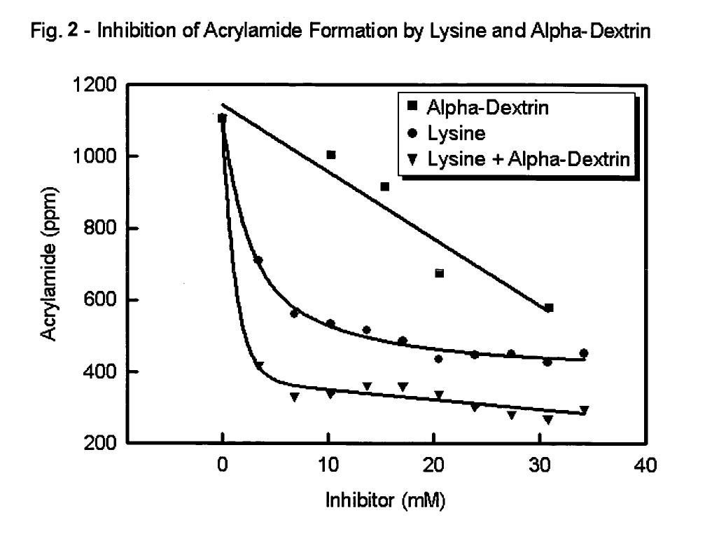

As seen in FIG. 2, acrylamide formation decreases in a linear fashion with increasing alpha-cyclodextrin concentration when no lysine is present. Acrylamide formation in the presence of lysine without alpha-cyclodextrin decreases by an exponential function. Without being bound by theory, it is believed that this is likely due to the fact that lysine carries two primary amines per molecule, which are capable of reacting with glucose and thereby prevent reaction of the asparagines primary amine with glucose. It is presumed that the inhibition of acrylamide by alpha-cyclodextrin is through sequestration of asparagine via binding of the asparagine in the hydrophobic core of the alpha-cyclodextrin molecule. It would have been predicted that lysine might also have bound to alpha-cyclodextrin so that inclusion of both alpha-cyclodextrin and lysine together would have resulted in a reduction of efficacy of both ingredients with regards to inhibiting acrylamide formation. Surprisingly, lysine does not seem to interfere with the ability alpha-cyclodextrin to interact with asparagine. Nor does alpha-cyclodextrin seem to significantly interfere with the interaction of lysine and glucose. The increased efficacy alpha-cyclodextrin in combination with lysine is further illustrated below in Table 2.

TABLE 2
Inhibition of Acrylamide Formation by
Amino Acid and Alpha-cyclodextrin

| | | Acrylamide (ppm) | | |
|---|---|---|---|---|
| Alpha- | | Alpha- | | |
| cyclodextrin | Lysine | cyclodextrin | Lysine | Alpha-cyclodextrin + |
| mM | mM | Only¹ | Only² | Lysine³ |
| 0 | 0 | 1121 | 1106 | 1104 |
| 10 | 3 | 915 | 709 | 420 |
| 15 | 7 | 675 | 561 | 333 |
| 21 | 10 | 579 | 534 | 339 |

¹Alpha-cyclodextrin was added to a solution of 50 mM Glucose, 50 mM Asparagine, 200 mM KH₂PO₄, pH 5.5, at the concentrations listed in the first column of the table and incubated for 16 h at 110 C.
²Lysine was added to a solution of 50 mM Glucose, 50 mM Asparagine, 50 mM KH₂PO₄, pH 5.5, at the concentrations listed in the second column of the table and incubated for 16 h at 110 C.
³Alpha-cyclodextrin and Lysine were added to a solution of 50 mM Glucose, 50 mM Asparagine, 200 mM KH₂PO₄, pH 5.5, at the concentrations listed in ihe first and second columns, respectively, of the table and incubated for 16 h at 110 C.

Gas Chromatography of Acrylamide

Instrument: Hewlett Packard Model 6890 with FID

OVEN

| | |
|---|---|
| Initial Temp: 100 C. | Maximum Temp: 260 C. |
| Initial Time: 0.5 min | Equil. Time: 0.00 min |

Ramps:

| Number | Rate (C/min) | Final Temp (C.) | Final Time (min) |
|---|---|---|---|
| 1 | 2.00 | 150 | 1.00 |
| 2 | 20.00 | 200 | 10.00 |
| 3 | 0.00 | (off) | |

| | |
|---|---|
| Post Temp: | 100 C. |
| Post Time: | 0.00 min |
| Run Time: | 39.00 min |

INLET (SPLIT/SPLITLESS)

| | |
|---|---|
| Mode: | Splitless |
| Initial temp: | 258 C. |
| Pressure: | 3.20 psi |
| Purge Flow: | 1.8 mL/min |
| Purge Time: | 0.00 min |
| Total flow: | 10.3 mL/min |
| Gas saver: | Off |
| Gas Type: | Helium |

COLUMN

| | |
|---|---|
| Capillary Column | |
| Model Number: | Restek 10637 Stabilwax |
| | (Crossbond Carbowax - PEG) |
| Max temperature: | 260 C. |
| Nominal length: | 15.0 m |
| Nominal diameter: | 530 um |
| Nominal film thickness: | 0.50 um |
| Mode: | constant flow |
| Initial flow: | 6.6 mL/min |
| Nominal init pressure: | 3.20 psi |
| Average velocity: | 57 cm/sec |
| Inlet: | Back Inlet |
| Outlet: | Back Detector (FID) |
| Outlet pressure: | ambient |

DETECTOR (FID)

| | |
|---|---|
| Temperature: | 260 C. |
| Hydrogen flow: | 45.0 mL/min |
| Air flow: | 400.0 mL/min |
| Mode: | Constant column + makeup flow |
| Combined flow: | 10.0 mL/min |
| Makeup flow: | On |
| Makeup Gas Type: | Helium |
| Lit offset: | 2.0 |

7673 INJECTOR

| | |
|---|---|
| Injector: | |
| Sample Washes | 3 |
| Sample Pumps | 2 |
| Injection Volume | 4.0 microliters |
| Syringe Size | 10.0 microliters |
| Nanoliter adapter | Off |
| PostInj Solvent A Washes | 2 |
| PostInj Solvent B Washes | 2 |
| Viscosity Delay | 0 seconds |
| Plunger Speed | Fast |
| PreInjection Dwell | 0.03 minutes |
| PostInjection Dwell | 0.03 minutes |

Miscellaneous: Inlet liner is a glasswool focusing liner. [SGE Focusliner P/N 092003]

Method for Determining Amino Acid Binding by Cyclodextrins

1. Solution D: For 20 ml of a 10 mM [14C]-asparagine solution, weigh 0.02642 g asparagine and dissolve in 20 ml 0.1 M Potassium Phosphate Buffer, pH 5.5. Add 100 ul of[14C]-Asparagine stock (10 uCi/100 ul) [11,000 dpm/100ul buffer].

2. Add increasing amounts of alpha-cyclodextrin to 2 ml aliquots of Solution D. In one embodiment, the following amounts of alpha-cyclodextrin were added to the 2 ml aliquots and vortexed to solubilize:
a. 0 mg
b. 25 mg
c. 50 mg
d. 75 mg
e. 100 mg
f. 150 mg
g. 200 mg
h. 300 mg
i. 500 mg

3. Incubate the samples in 2 above at 37 C for 2 hours with constant shaking.

4. The solutions are filtered through 0.45 um nylon filters and placed in HPLC autosampler vials.

5. Duplicate 100 uL aliquots of the solutions are measured, vortexed with a scintillation fluid (Packard Ultima Gold) and counted on a scintillation counter. Scintillation counts in dpm represent the amount of [14C]-asparagine remaining in solution.

6. The samples above are injected into an HPLC with a size exclusion column capable of resolving 300 to 7000 MW (e.g. Pharmacia Superdex Peptide column) equilibrated in a buffer of 0.1 M KH₂PO₄, pH 5.5 and eluted at a flow rate of 0.2 mL/min. A flow-thru scintillation detector is used to monitor the effluent for radioactivity.

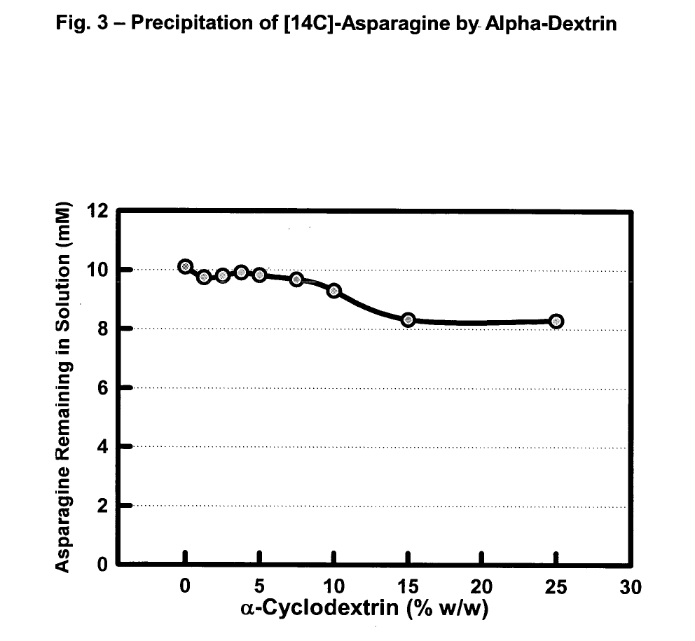

FIG. 3 shows the result of measuring the remaining [14C]-asparagine in solution as described in 5 above. Since the specific activity of the [14C]-asparagine is known, the asparagine DPM can be converted to a molar quantity. It is seen in FIG. 3 that increasing concentrations of alpha-cyclodextrin causes the removal or precipitation of asparagine from solution. The precipitation reaches a maximum of 20% of the total asparagine in solution. This demonstrates that one mode by which alpha-cyclodextrin may inhibit the reaction of asparagine and glucose to form acrylamide is by precipitation of asparagine.

Elution of the samples derived in 6 above on a molecular sizing column results in the fractionation of the solution components by their molecular weight. The shorter the retention time of a component on the molecular sizing column, the higher is its native molecular weight. If alpha-cyclodextrin and asparagine form a soluble complex in solution, then one would expect to see a new high molecular weight species result from the incubation of the two components.

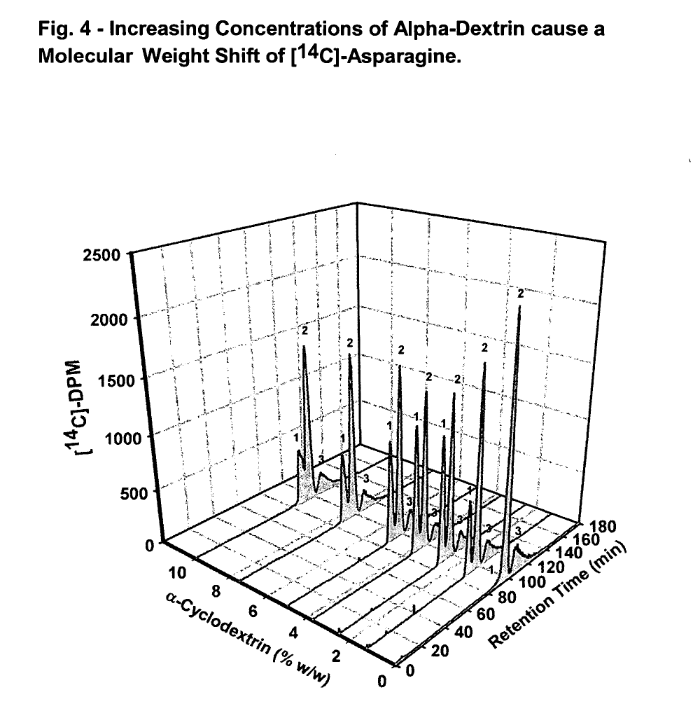

As seen in FIG. 4, three peaks are resolved on the molecular sizing column. Since the only element that is radiolabeled in the chromatogram is [14C]-asparagine, then all of the resolved peaks contain asparagine. The first chromatogram in the series contains no added alpha-cyclodextrin. Therefore, Peaks 2 and 3 represent free asparagine. On addition of alpha-cyclodextrin, a new Peak 1 appears and grows with increasing alpha-cyclodextrin concentration. Since this peak elutes at an earlier retention time than Peaks 2 or 3, it represents a new higher molecular weight species of [14C]-asparagine that is dependent on the presence of alpha-cyclodextrin. The calculated molecular weight of Peak 1 is ˜1100 Daltons, which is consistent with a 1:1 complex of alpha-cyclodextrin and [14C]-asparagine. Therefore, the conclusion of the experiment shown in FIG. 4 is that alpha-cyclodextrin binds free asparagine. While not being bound by theory, it is believed that it is the sequestration of asparagine from reaction with glucose that is the most likely mode by which alpha-cyclodextrin inhibits acrylamide formation.

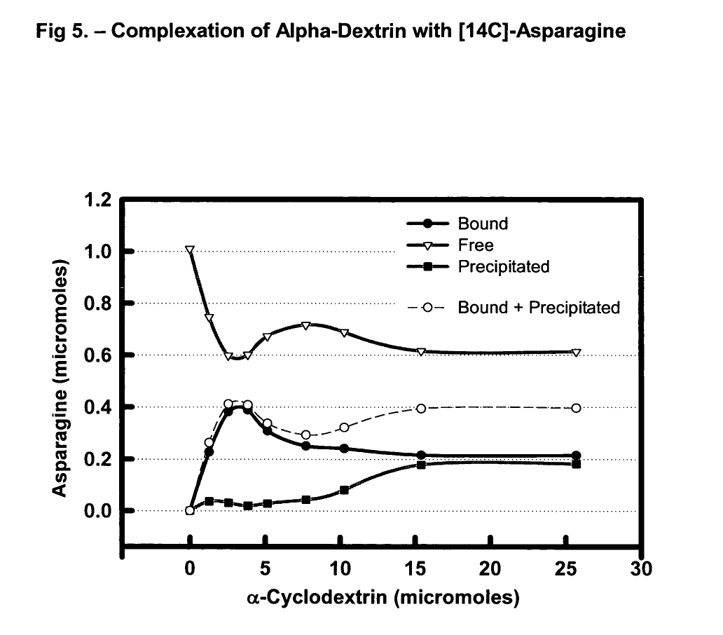

The alpha-cyclodextrin concentration dependence of the bound [14C]-asparagine, Peak 1, is illustrated in FIG. 5. Maximal binding of 0.41 micromolar asparagine occurs at a concentration of 2.6 micromolar alpha-cyclodextrin indicating that 16% of the available alpha-cyclodextrin is bound to asparagine. All species of asparagine, i.e. bound, precipitated and free are accounted for in FIG. 5.

Relative Activity of Cyclodextrin to Acrylamide Reactants and Inhibition of Acrylamide Formation.

The relative reactivity of alpha, beta, and gamma cyclodextrins was measured for affinity to asparagine, glucose and ability to inhibit acrylamide formation by the methods described above. Although all three cyclodextrins have the ability to inhibit acrylamide formation, with alpha-cyclodextrin being the most efficacious, only alpha-cyclodextrin is observed to directly bind asparagine. This indicates that, although beta and gamma cyclodextrins may bind asparagine, the association is too weak to survive resolution on a molecular sizing column. Alternatively, beta and gamma cyclodextrins may inhibit acrylamide formation by another undefined mechanism.

TABLE 3

| | | | | | Inhibition of | Inhibition of |
|---|---|---|---|---|---|---|
| | Asparagine | | Glucose | | in vitro | Acrylamide |
| | | Soluble | | Soluble | Acrylamide | Formation in |
| Ingredient | Precipitate | Complex | Precipitate | Complex | Formation | Cooked Cereal |
| Alpha- | + | +++ | N.D. | N.D. | +++ | +++ |
| cyclodextrin | | | | | | |
| Beta- | N.D. | N.D. | N.D. | N.D. | + | ++ |
| cyclodextrin | | | | | | |
| Gamma- | N.D. | N.D. | N.D. | N.D. | + | + |
| cyclodextrin | | | | | | |

N.D. = Not Detected
+ = minimal level
++ = moderate level
+++ = high level

All patents, patent documents, and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A food product having reduced acrylamide content at the time of consumption, said food product comprising
a) a first component that is a cyclodextrin; and
b) a second component that is a non-endogenous food ingredient material selected from amino acids, salts thereof and derivatives thereof.

2. The food product of claim 1, wherein the first and second components are incorporated in the food product in an amount sufficient to provide a food product having an acrylamide content that is less than 90% by parts of the acrylamide content of a like food product that does not contain the first and second components.

3. The food product of claim 1, wherein the food product is selected from the group consisting of baked goods, snack bars, fried or baked snack foods, dairy products, beverages, muffins, rolls, cakes, pies, crackers, pastries, biscuits, breads, grain based bars, granola bars, health food bars, fruit bars, potato crisps, corn chips, tortilla chips, extruded snacks, enrobed extruded snacks, pretzels, yogurt, pudding, nutritional beverages and energy drinks.

4. The food product of claim 1, wherein the food product is a ready-to-eat cereal

5. The food product of claim 1, wherein the food product comprises less than about 1000 ppm of acrylamide.

6. The food product of claim 1, wherein the cyclodextrin is alpha-cyclodextrin.

7. The food product of claim 1, wherein the second component is selected from the group consisting of lysine, isoleucine, phenylalanine, tyrosine, cysteine, cystine, leucine, methionine, serine, threonine, glutamate, aspartate, proline, tryptophan, valine, alanine, glycine, arginine, histidine and combinations thereof.

8. The food product of claim 1, wherein the second component is selected from the group consisting of one or more of salts of amino acids or one or more of derivatives of amino acids.

9. The food product of claim 1, wherein the food product comprises a grain.

10. The food product of claim 1, wherein the food product comprises a vegetable.

11. A packaged food product, wherein the food product is a food product of claim 1.

12. A food intermediate having reduced acrylamide content at the time of consumption, said food intermediate comprising
a) a first component that is a cyclodextrin; and
b) a second component that is a non-endogenous food ingredient material selected from amino acids, salts thereof and derivatives thereof.

13. The food intermediate of claim 12, wherein the first and second components are incorporated in the food intermediate in an amount sufficient to provide a food intermediate having a raw intermediate acrylamide content that is less than 90% by parts of the raw intermediate acrylamide content of a like product that does not contain the first and second components.

14. The food intermediate of claim 12, wherein the food intermediate is an additive, supplement or ingredient.

15. The food intermediate of claim 12, wherein the food intermediate has an as provided acrylamide content of less than about 1000 ppm of acrylamide.

16. The food intermediate of claim 12, wherein the cyclodextrin is alpha-cyclodextrin.

17. The food intermediate of claim 12, wherein the second component is selected from the group consisting of lysine, isoleucine, phenylalanine, tyrosine, cysteine, cystine, leucine, methionine, serine, threonine, glutamate, aspartate, proline, tryptophan, valine, alanine, glycine, arginine, histidine and combinations thereof.

18. A method of controlling the amount of measured acrylamide in a food product or food intermediate comprising:
a) selecting a food product or food intermediate in which the level of measured acrylamide is to be controlled; and
b) incorporating in the food product or food intermediate:
i) a first component that is a cyclodextrin; and
ii) a second component that is a non-endogenous food ingredient material selected from selected from amino acids, salts thereof and derivatives thereof.

19. The method of claim 18, wherein both the first and second components are topically applied to the food product or food intermediate.

20. The method of claim 18, wherein the first and second components are incorporated in the food product or food intermediate prior to cooking.
